(19) United States
(12) Patent Application Publication
(10) Pub. No.: US 2025/0017203 A1
(43) Pub. Date: Jan. 16, 2025

(54) LIQUID CARRIER CONCENTRATE COMPRISING AT LEAST ONE BENEFICIAL MICROORGANISM AND USES THEREOF

(71) Applicant: SPECIALTY OPERATIONS FRANCE, Lyon (FR)

(72) Inventors: Monique Adamy, Asnières-Sur-Seine (FR); Fernanda De Oliveira Barreto Costa, Paulínia (BR); Elisa Coelho, Paulínia (BR)

(73) Assignee: SPECIALTY OPERATIONS FRANCE, Lyon (FR)

(21) Appl. No.: 18/713,592

(22) PCT Filed: Nov. 24, 2022
(86) PCT No.: PCT/EP2022/083214

§ 371 Date: May 24, 2024

(30) Foreign Application Priority Data
Nov. 24, 2021 (EP) 21210154.7

(51) Int. Cl. A01N 25/22; A01N 25/04; A01N 63/22; A01N 63/38

(52) U.S. Cl. CPC A01N 25/22; A01N 25/04; A01N 63/22; A01N 63/38

(57) ABSTRACT

The present invention relates to a liquid carrier concentrate comprising at least one beneficial microorganism selected from the group consisting of Bacillus, Streptomyces, Beauveria, Trichoderma, Metarhizium, Paecilomyces, Isaria, Baculovirus, Azospirillum, Penicillium and Rhizobium and at least one dioxolane-based solvent. The present invention also relates to an agricultural active formulation obtainable by diluting or dispersing said liquid carrier concentrate. The invention also concerns a method for treating soils, plants and/or seeds to control pests and/or to regulate the growth of plants and/or to induce the defense response in plants and/or to enhance metabolic and physiological processes within plants and soils, by applying the liquid carrier concentrate or the agricultural active formulation.

The present invention relates to a liquid carrier concentrate comprising at least one beneficial microorganism selected from the group consisting of Bacillus, Streptomyces, Beauveria, Trichoderma, Metarhizium, Paecilomyces, Isaria, Baculovirus, Azospirillum, Penicillium and Rhizobium, at least one dioxolane-based solvent and at least one specific rheology modifier. The present invention also relates to an agricultural active formulation comprising said liquid carrier concentrate or obtainable by diluting said liquid carrier concentrate. The invention also concerns a method for treating soils, plants and/or seeds to control pests and/or to regulate the growth of plants and/or to induce the defense response in plants and/or to enhance metabolic and physiological processes within plants and soil by using said agricultural active formulation or liquid carrier concentrate.

### BACKGROUND OF THE INVENTION

In recent years, both environmental and human health concerns have fostered interest in promoting alternatives to synthetic pesticides.

Through the use of living microorganisms, natural substances or semiochemicals, biological control agents prevent or reduce damage from pests and pathogens, emerging as one of the most promising tools for sustainable agriculture.

However, the global rate of adoption of biological control-based solutions remains relatively low in comparison with conventional pesticides, with often less consistent biological efficacy reported in the field, in adverse conditions.

The main concern is the ability to provide an efficient concentrate composition formulated to keep the microorganisms stable, limit or prevent premature growth and/or germination before application, while maintaining their viability in the formulated composition over periods of storage. The formulated composition should in addition be readily available for dilution or addition to various applications.

It is especially challenging also to have a homogeneous composition of the microorganism particles, adequately dispersed in a liquid medium or solvent, preferably with a stability of the obtained suspension over extended periods of time, with limited phase separation (for example less than 25%), preferably with little or even without aggregation or sedimentation of particles of microorganisms or of their metabolites, while having preferably neither negative impact on the viability of microorganism nor negative impact on application properties, notably upon dilution of the composition, for instance in water.

Another well-known problem is that bacterial or fungal microbial spores have a strong tendency to agglomerate as such in concentrate formulations, or upon dilution in water. This causes significant application issues for the end user such as the risk of nozzles clogging on delivery devices, and/or the adhesion to the inner surface of a delivery tank (often referred to as “staining”), hence the lack of biological availability of microbial active and its metabolites to the targeted surface, with potential biological efficacy issues. There is a need for microbial formulations with enhanced dispersion characteristics, especially upon dilution in water prior to application.

Previous formulated compositions are notably disclosed in US 2011/0033436 which is directed to aqueous formulations of various spore forming bacteria and fungi. However, aqueous based formulations are problematic due to the nature of water and the need for harsh preservatives to prevent pathogens growth. Such preservatives can be harmful to the viability of beneficial microorganisms, impacting drastically their germination rate, once reactivated. Furthermore some types of microorganisms such as fungal spores need to be formulated in a medium free of water (or comprising a low concentration of water) to keep them in a dormant state, with inactivated metabolism, in order to achieve a reasonable shelf life, longer storage stability. Further, aqueous based formulations are not compatible with other non-aqueous agricultural products, which presents difficulty in applying the pesticide.

US 2017/0347665 discloses non-aqueous, non-oil microbial compositions and their use for the preparation of pesticides. These compositions contain a liquid carrier which is preferably selected from polyethylene glycol, glycerol, ethylene glycol, dipropylene glycol, propylene carbonate or mixture thereof. However, some of these organic solvents may in some circumstances be phytotoxic to the spores.

Thus there is a need for the provision of formulations containing at least one beneficial microorganism and a solvent having advantageously improved properties:
towards the beneficial microorganisms, notably:
   improved viability of the microorganism during storage,
   improved physical stability, with no or little sedimentation
in the applications, in particular compatible with other agricultural products, and with improved dispersion characteristics upon dilution in water,
safe towards the environment and human health.

### BRIEF DESCRIPTION OF THE INVENTION

It has been found, unexpectedly, that a liquid carrier concentrate, comprising at least one beneficial microorganism selected from the group consisting of Bacillus, Streptomyces, Beauveria, Trichoderma, Metarhizium, Paecilomyces, Isaria, Baculovirus, Azospirillum, Penicillium and Rhizobium, and at least one dioxolane-based solvent and at least one fumed silica surface-treated with polydimethylsiloxane as rheology modifier, advantageously provides superior long term stability, viability and growth of the beneficial microorganisms. The liquid carrier concentrates of the present invention can also be qualified as greener, or more environmentally friendly compared to traditional synthetic pesticide formulations.

The present invention further relates to an agricultural active formulation obtainable by diluting or dispersing the liquid carrier concentrate of the invention, preferably in water, generally with a dilution rate which ranges from 0.1% to 10% by volume.

The present invention also provides a method for treating soils, plants and/or seeds to control pests and/or to regulate the growth of plants and/or to induce the defense response in plants and/or to enhance metabolic and physiological processes within plants and soil by using said agricultural active formulation or liquid carrier concentrate, preferably comprising applying an effective amount of said agricultural active formulation or liquid carrier concentrate to plants (crop or undesired ones), seeds or to the soil.

### DETAILED DESCRIPTION OF THE INVENTION

The present invention relates to a liquid carrier concentrate, comprising at least one beneficial microorganism selected from the group consisting of Bacillus, Streptomyces, Beauveria, Trichoderma, Metarhizium, Paecilomyces, Isaria, Baculovirus, Azospirillum, Penicillium and Rhizobium, at least one dioxolane-based solvent and at least one rheology modifier composed of fumed silica surface-treated with polydimethylsiloxane.

The liquid carrier concentrate of the present invention may display one or more advantages, notably:
The liquid carrier concentrate may have an increased shelf-life in comparison to one or more controls, in particular the beneficial microorganisms may have an increased viability after storage for a defined period of time at a defined temperature, as compared to one or more controls,
The liquid carrier concentrate may be free of water, and therefore limits the need for preservatives, in particular no preservative or less preservative is needed,
The liquid carrier concentrate may have an improved physical stability and/or homogeneity, in particular no or little phase separation or sedimentation or aggregation may be observed, thus improving the handling of the liquid carrier concentrate, in comparison to one or more controls,
In comparison with one more controls, the liquid carrier concentrate may have enhanced dispersion characteristics and an improved homogeneity upon application, in particular the agglomeration issues known upon dilution are reduced, improving the handling of the agricultural active formulation obtainable by dilution of the liquid carrier concentrate,
The liquid carrier concentrate may have an improved compatibility when combined with fertilizers for in-furrow applications, or during planting or when combined with other agrochemical products in the spray tank mixture, in comparison with one or more controls,
The liquid carrier concentrate may boost or increase the germination rate of microorganisms and/or enhance the metabolites production of the microorganisms, upon application of the liquid carrier concentrate or of the agricultural active formulation obtainable by dilution of the liquid carrier concentrate in water, in comparison with one or more controls,
The liquid carrier concentrate may provide an increased or at least improved biological efficacy of microorganisms and/or their metabolites upon application, in particular when coated on the seed, or applied on the soil, either through application of the liquid carrier concentrate or a dispersion or dilution thereof in water, in comparison with one or more controls,
Seeds coated or soils treated with an effective amount of the liquid carrier concentrate and/or an effective amount of the agricultural active formulation of the invention may provide an enhanced plant growth, in comparison with seed coated or soils treated with an effective amount of one or more controls,
The number of root nodules of leguminous plants derived from seeds treated with an effective amount of the liquid carrier concentrate and/or an effective amount of the agricultural active formulation of the invention, may be higher, in comparison with the one of leguminous plants derived from seeds treated with one or more controls,
The liquid concentrate may provide an increased viability and/or survival rate of the microorganisms during or after application, in particular after coating on the seed, or application on the soil, of the liquid concentrate or a dispersion or dilution thereof in water, in comparison with one or more controls,
The liquid carrier concentrate may provide an increased germination rate of the microorganisms upon application, in particular after coating on the seed, or application on the soil of the liquid carrier concentrate or a dispersion or dilution thereof in water, in comparison with one or more controls.

As used herein, the term “control” refers to dried state of spores, or water-based concentrate of spores, or to other liquid carriers or solvents of comparison containing spores.

As used herein, the term “increased shelf-life” refers to the fact that the liquid carrier concentrate is able to increase the viability of the beneficial microorganism after a certain period of storage at a specific temperature, as compared to one or more controls.

As used herein, the term “increased germination rate” refers to the fact that a greater fraction of the dormant spores are able to germinate after dispersion of the liquid carrier concentrate in a water-based liquid as compared to one or more controls.

As used herein, the term “boost” refers to the fact that an improvement of the germination of dormant spores after dispersion of the liquid carrier concentrate in a water-based liquid as compared to one or more controls.

As used herein, the term “enhanced dispersion” refers to an improvement in one or more characteristics of microbial dispersion, as compared to one or more controls. Exemplary microbial dispersion characteristics include, but are not limited to, the percentage of microbes that exist as single cells/spores when the composition is diluted in water.

As used herein, the term “enhanced plant growth” refers to an improvement in one or more characteristics of plant growth and/or development as compared to one or more control plants. Exemplary plant growth/development characteristics include, but are not limited to, biomass, chlorophyll content, cold tolerance, drought tolerance, height, leaf length, leaf mass, leaf number, leaf surface area, root area, root diameter, root length, root mass, root nodulation (e.g., nodule mass, nodule number, nodule volume), root number, root surface area, root volume, salt tolerance, seed germination, seedling emergence, stomatal conductance and survival rate.

### Beneficial Microorganism

As used herein, the term “beneficial microorganism” means any microorganism, whether in a vegetative state, a dormant state (e.g., spore) or a whole broth culture, any substance derived from a microorganism (including proteins or secondary metabolites), or any fermentation product (e.g., supernatants, filtrates, extracts, etc.) that are beneficial to a plant.

According to the invention, the term “beneficial microorganisms” is intended to include (i) biopesticides, (ii) microorganisms that improve plant nutrition and (iii) microorganisms that induce the defense response in plants, or that are capable of enhancing metabolic & physiological processes within plants and soils.

In one embodiment, the beneficial microorganism may especially be a biopesticide.

As used herein, the term “pesticidal” means any agent or combination of agents that is pathogenic to at least one target pest (e.g., a nematode, an insect, an acari, a fungal pest, a bacterial pest, a viral pest), especially on a plant and/or a seed.

As used herein, the term “biopesticide” (which is equivalent to “microbial pesticide”), means any microorganism, whether in a vegetative state, a dormant state (e.g., spore) or a whole broth culture, any substance derived from a microorganism (e.g. proteins or metabolites), or any fermentation product (e.g., supernatants, filtrates, extracts, etc.) that are pathogenic to a pest (e.g., capable of attacking, infecting, killing, disabling, causing disease, compete with and/or causing injury to a pest), in particular on a plant and/or a seed, and is thus able to be used in the control of a pest by adversely affecting the viability or growth of the target pest. Non-limiting examples of “microbial pesticides” include microbial nematicides, microbial insecticides, microbial fungicides, microbial bactericides, and microbial virucides.

As used herein, “derived from” means directly isolated or obtained from a particular source or alternatively having identifying characteristics of a substance or organism isolated or obtained from a particular source. In the event that the “source” is an organism, “derived from” means that it may be isolated or obtained from the organism itself or medium used to culture or grow said organism.

As used herein, “whole broth culture” refers to a liquid culture containing both cells and media. If bacteria are grown on a plate the cells can be harvested in water or other liquid, whole culture.

As used herein, the term “supernatant” refers to the liquid remaining when cells grown in broth or are harvested in another liquid from an agar plate and are removed by centrifugation, filtration, sedimentation, or other means well known in the art.

As defined herein, “filtrate” refers to liquid from a whole broth culture that has passed through a membrane.

As defined herein, “extract” refers to liquid substance removed from cells by a solvent (water, detergent, buffer) and separated from the cells by centrifugation, filtration or other method.

As used herein, “metabolite” refers to a compound, substance or byproduct of a fermentation of a microorganism, or supernatant, filtrate, or extract obtained from a beneficial microorganism, for instance from a microorganism that has pesticidal and particularly, insecticidal activity.

As used herein, the terms “spore”, “microbial spore”, etc., has its normal meaning which is well known and understood by those of skill in the art (i.e., a microorganism in its dormant, protected state).

As used herein, the term “herbicide(s)” is intended to refer to any agent or combination of agents capable of killing weeds and/or inhibiting the growth of weeds (the inhibition being reversible under certain conditions), in particular on a plant and/or a seed.

As used herein, the term “fungicide(s)” is intended to refer to any agent or combination of agents capable of killing fungi and/or inhibiting fungal growth, in particular on a plant and/or a seed.

As used herein, the term “nematicide” or “nematicidal” is intended to refer to any agent or combination of agents capable of killing one or more nematodes and/or inhibiting the growth of one or more nematodes, in particular on a plant and/or a seed.

As used herein, the term “insecticide” or “insecticidal” is intended to refer to any agent or combination of agents capable of killing one or more insects and/or inhibiting the growth of one or more insects, in particular on a plant and/or a seed. As used herein, the term “acaricide” or “acaricidal” is intended to refer to any agent or combination of agents capable of killing one or more acarids and/or inhibiting the growth of one or more acarids, in particular on a plant and/or a seed.

An “agricultural active” formulation is intended to denote formulations which, either use in its concentrated form or in dilution in water to a targeted use rate, causes or provides a beneficial and/or a useful effect in agriculture and/or provides a biological activity in a soil or, above all, in a seed or a plant, for example to control pests and/or to regulate the growth of plants and/or to induce the defense response in plants and/or to enhance metabolic and physiological processes within soils or, above all, within plants.

According to the present invention, the beneficial microorganism is selected from the group consisting of Bacillus, Streptomyces, Beauveria, Trichoderma, Metarhizium, Paecilomyces, Isaria, Baculovirus, Azospirillum, Penicillium and Rhizobium, preferably from the group consisting of Bacillus, Beauveria, Trichoderma, Metarhizium, Paecilomyces, Isaria, Baculovirus, Azospirillum, Penicillium and Rhizobium, more preferably from the group consisting of Bacillus, Beauveria, Trichoderma, Paecilomyces and Rhizobium, in particular from the group consisting of Bacillus, Beauveria, Trichoderma and Paecilomyces.

According to an embodiment of the present invention, the beneficial microorganism is selected from the group consisting of Bacillus, Streptomyces, Beauveria, Penicillium, Metarhizium, Paecilomyces, Isaria, Baculovirus, Azospirillum and Rhizobium, in particular from the group consisting of Bacillus, Beauveria, Penicillium, Metarhizium, Paecilomyces, Isaria, Baculovirus and Azospirillum.

According to the present invention, the beneficial microorganism can possibly be selected from the group consisting of Streptomyces, Beauveria, Trichoderma, Metarhizium, Penicillium, Paecilomyces, Isaria, Baculovirus and Azospirillum for example from the group consisting of Beauveria, Trichoderma, Metarhizium, Penicillium, Paecilomyces, Isaria, Baculovirus and Azospirillum.

According to a particular embodiment of the invention, the beneficial microorganism is preferably selected from the group consisting of Beauveria, Trichoderma and Paecilomyces.

According to the invention and to any one of the invention embodiments and variants, the beneficial microorganism of the invention may be a biopesticide chosen from fungal spores or bacterial spores.

Examples of fungal spores or conidia that are insecticidal or nematicidal or fungicidal include but not limited to the following genii: Beauveria, Trichoderma, Metarhizium, Paecilomyces, and Isaria, specifically the following fungi; Beauveria bassiana, Trichoderma harzianum or Paecilomyces lilacinus.

Examples of bacterial spores include Bacillus, including but not limited to Bacillus agri, Bacillus aizawai, Bacillus albolactis, Bacillus amyloliquefaciens, Bacillus cereus, Bacillus circulans, Bacillus coagulans, Bacillus endoparasiticus, Bacillus endorhythmos, Bacillus firmus, Bacillus kurstaki, Bacillus lacticola, Bacillus lactimorbus, Bacillus lactis, Bacillus laterosporus, Bacillus lentimorbus, Bacillus licheniformis, Bacillus macerans, Bacillus megaterium, Bacillus medusa, Bacillus metiens, Bacillus natto, Bacillus nigricans, Bacillus popillae, Bacillus pumiliss, Bacillus pumilus, Bacillus siamensis, Bacillus sphaehcus, Bacillus spp., Bacillus subtilis, Bacillus thuringiensis, Bacillus uniflagellatus, plus those listed in the category of Bacillus Genus in the “Todar's Online Textbook of Bacteriology, (2009)”. Also included, even though the presence of Streptomyces in the liquid carrier concentrate according to the invention is not a preferred embodiment of the invention, are Streptomyces galbus, Streptomyces griseoviridis, Streptomyces candidus, Streptomyces lydicus, Streptomyces saraceticus, Streptomyces venezuelae, Streptomyces acidiscabies, Streptomyces goshikiensis, Streptomyces lavendulae, Streptomyces prasinus, Streptomyces prasinus, Streptomyces rimosus. Also included are Photorhabdus luminescens, Xenorhabdus nematophilus, Pantoea agglomerans, and those nematicidal bacterial antagonists listed in “Nematology Advances and Perspectives, Vol. 2 (2004)”.

The bacterial spores are, in a preferred embodiment, Bacillus subtilis, Bacillus amyloliquefaciens, or more preferably Bacillus thuringiensis.

Example of Penicillium spores include Penicillium bilaiae, Penicillium brevicompactum, Penicillium canescens, Penicillium expansum, Penicillium expansum, Penicillium fellatanum, Penicillium gaestrivorus, Penicillium glabrum, Penicillium janthinellum, Penicillium lanosocoeruleum, Penicillium radicum, Penicillium raistrickii.

In one embodiment of the present invention, beneficial microorganism agents are selected among root colonizing bacteria, nitrogen-fixing bacteria and/or inoculants, for example Rhizobium leguminosarum, Rhizobium tropici, Rhizobium loti, Rhizobium trifolii, Rhizobium meliloti, Rhizobium fredii, or preferably: Azorhizobium caulinodans, Pseudomonas, Azospirillum, Azotobacter, Bradyrhizobium.

Beneficial microorganism agents such as fungi or bacteria may be obtained by conventional fermentation processes. The fermentation can be carried out using solid, semi-solid or liquid nutrient media. If spores such as conidia are used, preference is given to solid or semi-solid nutrient media. The nutrient media contain the nutrients suitable and known for the cultivation of the respective microorganisms, in particular one or more metabolizable carbon sources or nitrogen sources and mineral salts. The fermentation is generally carried out at temperatures between about 3° C. and about 40° C., preferably between 20° C. and 35° C. For example, a representative fermentation is described in U.S. Pat. No. 5,804,208.

A fermentation process comprises in general the steps of a) incubating spores such as conidia of a microorganism in or on a nutrition medium (such as agar with further additives such as oatmeal); b) separating spores such as conidia from the nutrition medium after the incubation time, (e.g., by shake off the conidia from the medium, centrifuging, filtrating); and optionally c) preparing an emulsion of said isolated conidia. The person skilled in the art is well aware how to adapt fermentation to a given microorganism such as fungi or bacteria.

### Dioxolane-Based Solvent

As used herein the expression “dioxolane-based solvent” preferably refers to a compound of formula (I):

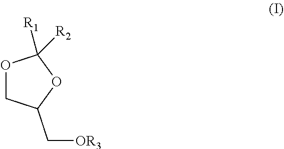

wherein R₁ and R₂, independent from one another, are selected in the group consisting of: a linear or branched C₁-C₁₂ alkyl, a C₄-C₁₂ cycloalkyl or an aryl,
R₃ is H, a linear or branched alkyl, a cycloalkyl, or a —C(═O)R₄ group, with R₄ being a linear or branched C₁-C₄ alkyl or C₅-C₆ cycloalkyl.

In a preferred embodiment, R₁ and R₂, independently from one another, are selected in the group consisting of: methyl, ethyl, isopropyl, n-propyl, isobutyl, n-butyl, tert-butyl, n-pentyl, cyclopentyl, cyclohexyl or phenyl.

Advantageously, in formula I above R₃ is H or a —C(═O)R₄ group, with R₄ being methyl, ethyl, isopropyl, n-propyl, isobutyl, n-butyl or tert-butyl. More preferably, R₃ is H.

One preferred embodiment is when R₁ and R₂ are methyl and R₃ is H. In this case, the compound is commercially available, for example under the name Rhodiasolv® Li-Tec 2V or Solketal. This compound can be synthesized by reaction between glycerol and acetone, under well-known classical conditions.

Advantageously, in formula (I) above, R₃ is H or a —C(═O)R₄ group, with R₄ being methyl, ethyl, isopropyl, n-propyl, isobutyl, n-butyl or tert-butyl. More preferably, R₃ is H.

One very preferred embodiment is when R₁ and R₂ are methyl and R₃ is H. A corresponding commercial compound is for example Rhodiasolv® Li-Tec 2V, Augeo® SL191 or Solketal. This compound can be synthesized by reaction between glycerol and acetone, under well-known classical conditions. Glycerol can be for instance obtained as a coproduct from biodiesel production during the transesterification of triglycerides.

One embodiment is to have R₁ and R₂ are methyl and R₃ is a —C(═O)R₄ group, with R₄ being methyl. A corresponding commercial compound can be synthesized by transesterification of Solketal with an alkyl acetate, under well-known classical conditions.

In another embodiment, R₁ is methyl, R₂ isobutyl and R₃ is H. A corresponding commercial compound can be synthesized by reaction between glycerol and methyl-isobutyl ketone, under well-known classical conditions.

In a less preferred embodiment, R₁ is methyl, R₂ is phenyl and R₃ is H. It can be synthesized by reaction between glycerol and acetophenone, under well-known classical conditions.

According to a specific embodiment, the compound of formula (I) is a bio-based compound. According to a specific embodiment, the at least one solvent contained in the liquid carrier concentrate of the invention comprises a compound of formula (I) and a compound of the following formula (II), wherein R₁, R₂ and R₃ have the same meaning as for formula (I):

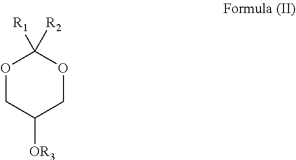

Advantageously the at least one solvent used in the solvent-based liquid carrier concentrate according to the invention, and in particular the at least one compound of formula (I) used in the solvent-based liquid carrier concentrate according to the invention, are inert towards the microorganism(s), in particular the compound of formula (I) has little or even no phytotoxic effect towards the microorganism(s).

### Liquid Carrier Concentrate

According to the present invention, the liquid carrier concentrate comprises:
at least one beneficial microorganism as defined above, and
at least one dioxolane-based solvent, preferably at least one solvent of formula (I), as defined above, and
at least one rheology modifier chosen from fumed silicas surface-treated with polydimethylsiloxane (PDMS).

It has been unexpectedly found that the specific combination of compounds comprised in this liquid carrier concentrate can advantageously provide, preferably in addition to bring suspension and shear-thinning properties or anti-settling properties and/or to allow to adjust the viscosity at a very suitable range for the application, superior long term stability when the liquid carrier concentrate is at rest or in storage, good and improved ease of dispersion, suitable facility of pourability and/or good physical compatibility with the different species of the liquid carrier concentrate, while preferably neither impacting negatively the viability of microorganism(s) nor impacting negatively application properties, notably upon dilution of the liquid carrier concentrate, in particular in water.

The fumed silica surface-treated with polydimethylsiloxane contained in the liquid carrier concentrate according to the invention has generally a BET specific surface area ranging from 60 to 180 m²/g, in particular 80 to 140 m²/g, notably 80 to 120 m²/g.

The BET specific surface area is generally measured by nitrogen adsorption using the BET (Brunauer, Emmet, Teller) technique, well known by the person skilled in the art.

It can be determined in accordance with DIN ISO 9277.

According to an embodiment, the BET specific surface area of the fumed silica surface-treated with PDMS used in the liquid carrier concentrate of the present invention ranges from 60 to 160 m²/g, preferably from 70 to 150 m²/g, in particular from 75 to 145 m²/g. This BET specific surface area can range from 80 to 140 m²/g, for instance from 70 to 130 m²/g.

According to another, and preferred, embodiment, the BET specific surface area of the fumed silica surface-treated with PDMS used in the liquid carrier concentrate of the present invention ranges from 60 to 140 m²/g, preferably from 70 to 130 m²/g, in particular from 75 to 125 m²/g. This BET specific surface area can range from 80 to 120 m²/g, for instance from 90 to 110 m²/g.

The fumed silica surface-treated with polydimethylsiloxane comprised in the liquid carrier concentrate according to the invention, and possibly having a BET specific surface area in the ranges above-mentioned, may present a pH value (in 4% dispersion) from 4.0 to 6.5. This pH value can range from 4.0 to 6.0 or from 4.5 to 6.5.

The fumed silica surface-treated with PDMS comprised in the liquid carrier concentrate according to the invention may have a carbon content (measured according to ISO-3262-20 for instance) of at least 3.0%, in particular from 3.0 to 7.0%, for example from 3.0 to 6.0%, or even from 3.5 to 5.0%.

The fumed silica surface-treated with polydimethylsiloxane used in the liquid carrier concentrate of the invention is advantageously hydrophobic.

Aerosil® R 202, marketed by Evonik, is an example of fumed silica surface-treated with PDMS which can be used in the liquid carrier concentrate according to the present invention.

The liquid carrier concentrate according to the invention generally comprises 0.1 to 12% by weight, preferably 0.1 to 10% by weight, more preferably 0.5 to 7% by weight, in particular 1.0 to 5.0% by weight (relative to the total weight of the liquid carrier concentrate) of the at least one rheology modifier composed of fumed silica surface-treated with polydimethylsiloxane.

In order to disperse the fumed silica surface-treated with PDMS in a given fluid, high shear mixing can be desirable to form a gel as it is known in the art.

According to an embodiment, the liquid carrier concentrate of the invention comprises:
at least one beneficial microorganism selected from the group consisting of Bacillus, Beauveria, Trichoderma, Metarhizium, Paecilomyces, Isaria, Baculovirus, Azospirillum, Penicillium and Rhizobium, preferably from the group consisting of Bacillus, Beauveria, Trichoderma and Paecilomyces, in particular from Beauveria, Trichoderma, Paecilomyces,
at least one (dioxolane-based) solvent, this solvent being a compound of formula (I):

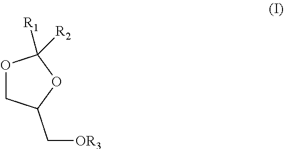

wherein R₁ and R₂ are methyl, and R₃ is H, and
at least one rheology modifier, said rheology modifier being a fumed silica surface-treated with polydimethylsiloxane having a BET specific surface area ranging from 60 to 180 m²/g, preferably from 60 to 160 m²/g, particularly from 60 to 140 m²/g.

According to another embodiment, the liquid carrier concentrate of the invention comprises:
at least one beneficial microorganism selected from the group consisting of Bacillus, Beauveria, Trichoderma, Metarhizium, Paecilomyces, Isaria, Baculovirus, Azospirillum, Penicillium and Rhizobium, preferably from the group consisting of Bacillus, Beauveria, Paecilomyces and Trichoderma, in particular from Beauveria, Trichoderma, Paecilomyces,
at least one (dioxolane-based) solvent, this solvent being a compound of formula (I):

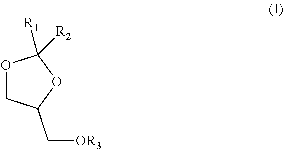

wherein R₁ and R₂ are methyl and R₃ is a —C(═O)R₄ group, with R₄ being methyl, and
at least one rheology modifier, said rheology modifier being a fumed silica surface-treated with polydimethylsiloxane having a BET specific surface area ranging from 60 to 180 m²/g, preferably from 60 to 160 m²/g, particularly from 60 to 140 m²/g.

According to a particular embodiment, the liquid carrier concentrate according to the invention has a viscosity, measured at 20 rpm using a Brookfield RV viscometer at 25° C. and at atmospheric pressure (1.013×10⁵ Pa), which ranges from 500 mPa·s to 5 000 mPa·s; more preferentially from 700 to 3 000 mPa·s; even more preferentially from 700 to 2 500 mPa·s.

The liquid carrier concentrate according to the invention may further contain additives different from the beneficial microorganism, the dioxolane-based solvent and the fumed silica surface-treated with PDMS as described above. These further additives are preferably selected from the group consisting of surfactants, binders, diluents, solvents, absorbents, stabilizers, dispersants, wetting agents, emulsifying agents, retention and rainfastness agents, antifoam agents, antifreeze agents, antioxidants, dyes and pigments, water-repellents, UV-stabilizers, adjuvants, viscosity modifiers, penetrants, sequestering agents and/or preservatives.

Each additive can be present in the liquid carrier concentrate according to the invention in an amount ranging from 0% to 20% by weight, in particular from 0% to 10% by weight, relative to the total weight of the liquid carrier concentrate. Each additive can be for instance present in the liquid carrier concentrate according to the invention in an amount ranging from 0.1% to 20% by weight, in particular from 0.1% to 10% by weight, relative to the total weight of the liquid carrier concentrate. Each additive can be present in the liquid carrier concentrate according to the invention in an amount preferably ranging from 0% to 5% by weight, notably from 0.1% to 5% by weight, relative to the total weight of the liquid carrier concentrate.

The person skilled in the art will be able to choose these optional additives and their amounts so that they do not harm the properties of the liquid carrier concentrate of the present invention.

According to a more particular, and preferred, embodiment, the liquid carrier concentrate of the invention further comprises at least one surfactant, in addition to, as defined above, beneficial microorganism(s), ester-amide solvent(s) and fumed silica(s) surface-treated with PDMS.

Suitable surfactants are surface-active compounds, such as anionic, nonionic and amphoteric surfactants, block polymers, polyelectrolytes, and mixtures thereof. Such surfactants can be used as emulsifier, dispersant, solubilizer, wetter, penetration enhancer, protective colloid, or adjuvant. Examples of surfactants are listed in Mccutcheon's, Vol. 1, Emulsifiers & De-tergents, Mccutcheon's Directories, Glen Rock, USA, 2008 (International Ed. or North American Ed.).

Suitable anionic surfactants are in particular alkali, alkaline earth or ammonium salts of sulfonates, sulphates, phosphates, carboxylates, and mixtures thereof. Examples of sulphonates are typically alkylarylsulphonates, diphenylsulphonates, alpha-olefin sulphonates, lignine sulphonates, sulphonates of fatty acids and oils, sulphonates of ethoxylated alkylphenols, sulphonates of alkoxylated arylphenols, sulphonates of condensed naphthalenes, sulphonates of dodecyl- and tridecylbenzenes, sulphonates of naphthalenes and alkylnaphthalenes, sulfosuccinates or sulfosuccinamates. Examples of sulphates are typically sulfates of fatty acids and oils, sulphates of ethoxylated alkylphenols, sulphates of alcohols, sulphates of ethoxylated alcohols, sulphates of fatty acid esters. Examples of phosphates are typically phosphate esters. Examples of carboxylates are typically alkyl carboxylates, and carboxylated alcohol or alkylphenol ethoxylates.

Suitable nonionic surfactants are in particular alkoxylates, N-substituted fatty acid amides, amine oxides, esters, sugar-based surfactants, polymeric surfactants, and mixtures thereof. Examples of alkoxylates are typically compounds such as alcohols, alkylphenols, amines, amides, arylphenols, fatty acids or fatty acid esters which have been alkoxylated with 1 to 50 equivalents. Ethylene oxide and/or propylene oxide may be employed for the alkoxylation, preferably ethylene oxide. Examples of N-substituted fatty acid amides are typically fatty acid glucamides or fatty acid alkanolamides. Examples of esters are typically fatty acid esters, glycerol esters or monoglycerides. Examples of sugar-based surfactants are typically sorbitans, ethoxylated sorbitans, sucrose and glucose esters or alkylpolyglucosides. Examples of polymeric surfactants are typically homo- or copolymers of vinylpyrrolidone, vinylalcohols, or vinylacetate.

Suitable amphoteric surfactants are in particular alkylbetains and imidazolines.

Suitable block polymers are in particular block polymers of the A-B or A-B-A type comprising blocks of polyethylene oxide and polypropylene oxide, or of the A-B-C type comprising alkanol, polyethylene oxide and polypropylene oxide.

Suitable polyelectrolytes are in particular polyacids or polybases. Examples of polyacids are typically alkali salts of polyacrylic acid or polyacid comb polymers. Examples of polybases are typically polyvinylamines or polyethylene amines

Preferably, in such a particular embodiment, the at least one surfactant contained in the liquid carrier concentrate is at least one non-ionic surfactant.

The liquid carrier concentrate according to the invention may then comprise 0.1 to 10% by weight, in particular 0.5 to 7% by weight, for example 1.0 to 5.0% by weight (relative to the total weight of the liquid carrier concentrate) of surfactant(s), preferably of non-ionic surfactant(s).

The liquid carrier concentrate may be preferentially in the form of a dispersion, a suspension of the beneficial microorganisms in the solvent alone or possibly in the presence of water, a co-solvent such as glycols like glycerol or polyethyleneglycol.

The liquid carrier concentrate of the invention can be in the form of a concentrated aqueous emulsion (EW), wherein the dioxolane-based solvent and the beneficial microorganism form an emulsion in water.

The liquid carrier concentrate of the present invention comprises at least one beneficial microorganism.

Preferably, the amount of beneficial microorganism in the liquid carrier concentrate according to the invention ranges from 1 to 95% by weight, in particular from 3 to 70% by weight, for instance from 3 to 60% by weight, and even from 5 to 40% by weight, relative to the total weight of the liquid carrier concentrate.

The amount of beneficial microorganism in the liquid carrier concentrate may usually range from 1.5×10⁴ CFU/g to 1×10¹¹ CFU/g, preferentially from 1×10⁶ CFU/g to 5×10¹⁰ CFU/g.

The liquid carrier concentrate of the present invention generally comprises at least 5 wt %, more particularly from 5 to 99 wt %, for instance from 5 to 97% wt %, notably from 5 to 95 wt % of dioxolane-based solvent (in particular the solvent of formula (I) and the different embodiments), based on the total weight of the solvent-based liquid concentrate (i.e. of the liquid carrier concentrate).

The liquid carrier concentrate of the present invention comprises preferably at least 40 wt %, more preferably at least 60 wt %, or even at least 80 wt %, of dioxolane-based solvent as defined above (in particular the solvent of formula (I) and the different embodiments), based on the total weight of the liquid carrier concentrate.

It can comprise from 40 to 99 wt %, in particular from 40 to 97% wt %, for example from 40 to 95 wt %, notably from 40 to 90 wt % of dioxolane-based solvent as defined above (in particular the solvent of formula (I) and the different embodiments), based on the total weight of the liquid carrier concentrate.

It can also comprise from 60 to 99 wt %, in particular from 60 to 97% wt %, for example from 60 to 95 wt %, notably from 60 to 90 wt %, or even from 60 to 80 wt %, of dioxolane-based solvent as defined above (in particular the solvent of formula (I) and the different embodiments), based on the total weight of the liquid carrier concentrate.

In some variants, the liquid carrier concentrate of the present invention comprises from 80 to 99 wt %, in particular from 85 to 97% wt %, for example from 90 to 97 wt %, of dioxolane-based solvent as defined above (in particular the solvent of formula (I) and the different embodiments), based on the total weight of the liquid carrier concentrate.

Known conventional methods for preparing agricultural products may be implemented. It is possible to undertake this by simply mixing the constituents.

### The Additional Agricultural Materials

The liquid carrier concentrate according to the invention may further comprise at least one additional agricultural material chosen from pesticides different from the beneficial microorganism agents as described above, nutrients, biostimulants, plant growth regulators, and mixtures thereof.

According to the invention, the additional agricultural material(s) which may be used in the liquid carrier concentrate, are different from the beneficial microorganism used in the liquid carrier concentrate of the invention.

The liquid carrier concentrate according to the invention may comprise at least one pesticide different from the beneficial microorganism used in such liquid carrier concentrate.

For example, these pesticides may be chosen from fungicides, herbicides, insecticides, algicides, molluscicides, miticides, nematicides, and rodenticides.

The person skilled in the art is familiar with such pesticides, which can be found, for example, in the Pesticide Manual, 16th Ed. (2013), The British Crop Protection Council, London.

If the liquid carrier concentrate according to the invention comprises one or more additional pesticides different from the beneficial microorganism as described above, it is understood that those skilled in the art will choose the pesticide(s) which will not adversely affect the effectiveness of the beneficial microorganism.

The liquid carrier concentrate according to the invention may comprise at least one nutrient. “Nutrients” refer to chemical elements and compounds which are desired or necessary to promote or improve plant growth. Nutrients generally are described as macronutrients or micronutrients.

Suitable nutrients for use in the liquid carrier concentrate according to the invention may be micronutrient compounds, preferably those which are solid at room temperature (about 25° C.) or are partially soluble.

Micronutrients typically refer to trace metals or trace elements, and are often applied in lower doses. Suitable micronutrients include trace elements selected from zinc, boron, chlorine, copper, iron, molybdenum, and manganese.

The micronutrients may be in a soluble form or included as insoluble solids, and may be in the form of salts or chelates. Preferably, the micronutrient is in the form of a carbonate or oxide.

Preferably, the micronutrients may be selected from zinc, calcium, molybdenum or manganese, or magnesium. More preferentially micronutrients for use in the liquid carrier concentrate according to the invention may be selected from zinc oxide, manganese carbonate, manganese oxide, or calcium carbonate.

The liquid carrier concentrate according to the present invention may also comprise at least one macronutrient.

Macronutrients typically refer to those comprising nitrogen, phosphorus, and potassium, and typically include fertilizers such as ammonium sulphate, and water conditioning agents. Suitable macronutrients include fertilisers and other nitrogen, phosphorus, or sulphur containing compounds, and water conditioning agents.

Suitable fertilisers include inorganic fertilisers that provide nutrients such as nitrogen, phosphorus, potassium or sulphur. Examples of such fertilisers include:
for nitrogen as the nutrient: nitrates and or ammonium salts such as ammonium nitrate, including in combination with urea e.g. as uran type materials, calcium ammonium nitrate, ammonium sulphate nitrate, ammonium phosphates, particularly mono-ammonium phosphate, di-ammonium phosphate and ammonium polyphosphate, ammonium sulphate, and the less commonly used calcium nitrate, sodium nitrate, potassium nitrate and ammonium chloride;
for phosphorus as the nutrient: acidic forms of phosphorus such as phosphoric, pyrophosphoric or polyphosphoric acids, but more usually salt forms such as ammonium phosphates, particularly mono-ammonium phosphate, di-ammonium phosphate, and ammonium polyphosphate, potassium phosphates, particularly potassium dihydrogen phosphate and potassium polyphosphate;
for sulphur as the nutrient: ammonium sulphate and potassium sulphate, e.g. the mixed sulphate with magnesium.

The liquid carrier concentrate according to the invention may comprise at least one biostimulant.

The term “biostimulant” is intended to mean a compound which may enhance metabolic or physiological processes such as respiration, photosynthesis, nucleic acid uptake, ion uptake, nutrient delivery, or a combination thereof.

Non-limiting examples of biostimulants include seaweed extracts (e.g., ascophyllum nodosum), humic acids (e.g., potassium humate), fulvic acids, myoinositol, glycine, and combinations thereof.

The liquid carrier concentrate according to the invention may comprise at least one plant growth regulator.

Plant growth regulators mean active ingredients used to influence the growth characteristics of plants. Examples of plant growth regulators which may be used in the present disclosure include, but are not limited to: 1-naphthaleneacetic acid, 1-naphthaleneacetic acid-salt, 1-napthol, 2,4-dichlorophenoxyacetic acid (2,4-D), 2,4-DB, 2,4-DEP, 2,3,5-triiodobenzoic acid, 2,4,5-trichlorophenoxyacetic acid, 2-naphthoxyacetic acid, 2-naphthoxyacetic acid sodium salt, 3-chloro-4-hydroxyphenylacetic acid, 3-indoleacetic acid, 4-biphenylacetic acid, 4-chlorophenoxyacetic acid (4-CPA), 4-hydroxyphenylacetic acid, 6-benzylaminopurine, auxindole, a-naphthaleneacetic acid K-salt, β-naphfhoxyacetic acid, p-chlorophenoxyacetic acid, dicamba, dichlorprop, fenoprop, indole-3-acetic acid (IAA), indole-3-acetyl-DL-aspartic acid, indole-3-acetyl-DL-tryptophan, indole-3-acetyl-L-alanine, indole-3-acetyl-L-valine, indole-3-butyric acid (IBA), indole-3-butyric acid K-salt, indole-3-propionic acid; a-naphthaleneacetic acid, methyl indole-3-acetate, naphthaleneacetamide, naphthaleneacetic acid (NAA), phenylacetic acid, picloram, potassium naphthenate, sodium naphthenate, 4-hydroxyphenethyl alcohol, 4-CPPU, 6-benzylaminopurine (BA), 6-(Y,Y-dimethylallylamino) purine (2iP), 2-iP-2HCl, adenine, adenine hemisulfate, benzyladenine, kinetin, meta-topolin, N6-benzoyladenine, N-benzyl-9-(2-tetrahydropyranyl) adenine (BP A), N-(2-chloro-4-pyridyl)-N-phenylurea, gibberellic acid (GA3), gibberellins, gibberellins A4+A7 (GA n), ethylene and abscisic acid.

Preferably, when the liquid carrier concentrate according to the invention further comprises at least one additional agricultural material, the amount of additional agricultural material(s) in the liquid carrier concentrate ranges from 0.01 to 60% by weight, more preferentially from 0.05 to 30% by weight; even more preferentially from 0.1 to 20% by weight; and even from 1 to 10% by weight, relative to the total weight of the liquid carrier concentrate.

The total content of additional agricultural material(s) in the liquid carrier concentrate may range from 1 to 60% by weight, more preferentially from 2 to 30% by weight, and even more preferentially from 5 to 20% by weight, relative to the total weight of the liquid carrier concentrate according to the invention.

### Agricultural Targets

According to the invention the term “agricultural target” is intended to cover plant parts and soil.

In one exemplary, and preferred, embodiment, the agricultural target is a plant part.

As used herein, the term “plant part” is to be understood as meaning all parts and organs of plants above and below the ground, such as shoot, leaf, flower and root, examples which may be mentioned being leaves, needles, stalks, stems, flowers, fruit bodies, fruits, seeds, roots, tubers and rhizomes. The plant parts also include harvested material and vegetative and generative propagation material (e.g., cuttings, tubers, rhizomes, off-shoots and seeds, etc.).

In one particular, and preferred, embodiment, the agricultural target is plant seed.

In another embodiment, the agricultural target is plant foliage.

As used herein, the term “foliage” is intended to mean all parts and organs of plants above the ground. Non-limiting examples include leaves, needles, stalks, stems, flowers, fruit bodies, fruits, etc. As used herein, the term “foliar application”, “foliarly applied”, and variations thereof, is intended to include application of a formulation to the foliage or above ground portions of the plant, (e.g., the leaves of the plant).

In another embodiment, the agricultural target is soil.

Agricultural growth medium, or other agricultural substrates, are also considered as possible agricultural targets in the sense of the present invention.

The term “agricultural target” does not cover microbial culture media used in microbiology.

In any case, according to the invention, the agricultural target of the invention is thus different from a culture media used in microbiology.

According to any one of the invention embodiments, the agricultural target may cover various crops and plants.

The agricultural target and the use in agriculture according to the invention do not comprise/cover the animal health and in particular the use against parasites in or on animals. The advantageous agricultural target or use in agriculture according to the present invention is the applications regarding plants or seeds.

### Agricultural Active Formulation

The present invention is also relative to an agricultural active formulation comprising the liquid carrier concentrate in accordance with the invention as defined above.

According to an embodiment, the present invention relates to an agricultural active formulation obtainable, or which is obtained, by diluting or dispersing the liquid carrier concentrate of the invention.

According to this embodiment, the agricultural active formulation is generally a dilution or dispersion of the liquid carrier concentrate with a dilution ratio which may vary significantly depending notably on the crop and the target, for example from grams to kgs of the formulation per hectare.

According to this embodiment, the liquid carrier concentrate is typically diluted in water.

In an embodiment, the agriculture active formulation in accordance with the invention is not in an encapsulated form. In other words, in this embodiment, the agriculture active formulation of the invention is not encapsulated in a material. And even without such encapsulation, the viability of the beneficial microorganisms is advantageously ensured.

Method for Treating Soils, Plants and/or Seeds

The present invention also provides a method for treating soils, plants and/or seeds, preferably to control pests and/or to regulate the growth of plants and/or to induce the defense response in plants and/or to enhance metabolic and physiological processes within plants and soils, by applying the liquid carrier concentrate of the present invention or the agricultural active formulation of the present invention to at least one plant, area adjacent to a plant, soil adapted to support growth of a plant, root of a plant, foliage of a plant, and/or seed adapted to produce a plant.

The method may be performed at any stage of development of the plant. The liquid carrier concentrate or the agricultural active formulation of the present invention may be applied on the whole plant or on parts thereof.

More particularly, the method according to the invention is for treating plants and/or seeds, preferably to control pests and/or to regulate the growth of plants and/or to induce the defense response in plants and/or to enhance metabolic and physiological processes within plants, by applying the liquid carrier concentrate of the present invention or the agricultural active formulation of the present invention to at least one plant, area adjacent to a plant, root of a plant, foliage of a plant, and/or seed adapted to produce a plant.

Preferably the method comprises the application of an effective amount of the liquid carrier concentrate or of the agricultural active formulation to plants (in particular crop or undesired ones), seeds or to the soil, in particular next to the plant or the seed.

More particularly, the method comprises the application of an effective amount of the liquid carrier concentrate or of the agricultural active formulation to plants (in particular crop or undesired ones) or to seeds, in particular next to the plant or the seed.

As used herein, the expression “effective amount” is defined as the amount of the beneficial microorganism sufficient to provide the beneficial effect to the plant (or to the seed).

For instance, when the beneficial microorganism is a biopesticide, the terms “effective amount” may be defined as the amount of the biopesticide sufficient to cause infection in the pest which will then lead to the controlling of pests. The actual effective amount in absolute value may depend on various factors including, but not limited to, the mortality rate of the pest or pests relative to the rate at which the biopesticide is applied, synergistic or antagonistic interactions between the other active or inert ingredients which may increase or reduce the activity of the biopesticide, the inherent susceptibility of the life stage and species of pest, and the stability of the biopesticide in compositions.

The “effective amount” of the beneficial microorganism, for instance the biopesticide, of the invention may be determined, e.g., by a routine dose response experiment.

Preferably, the method of the present invention is applied to seeds. Such method is preferably carried out by coating the seeds with the agricultural active formulation or the liquid carrier concentrate. Suitable known coating techniques may be utilized to coat the seeds or agglomeration of seed, and any suitable equipment or technique may be employed. Equipment that may be utilized for coating can include but are not limited to drum coaters, rotary coaters, tumbling drums, fluidized beds and spouted beds. The seeds may be coated via a batch or a continuous coating process.

The method of the present invention may be applied to any plant in need of treatment, in particular landscape plants, fruit trees, nut trees, fruit vines, vegetable crops and cereal crops.

The method of the present invention may be applied onto the foliar system of the plant. Such application is preferably carried out by spraying an agricultural active formulation or the liquid carrier concentrate of the present invention onto the leaves of the plant. For example, the agricultural active formulation or the liquid carrier concentrate can be sprayed onto a field using appropriate means well known in agriculture.

In a general manner, the invention can be easily carried out using conventional and commercially available application equipment.

The method of the present invention may also be applied to an area where crops are grown.

In a specific embodiment, the method of the present invention may include the application of an herbicide, a fungicide, an insecticide and or a foliar fertilizer.

The liquid carrier concentrate of the invention and the agricultural active formulation of the invention can possibly be in a non-encapsulated form (in other words, not encapsulated in a material). For example, in the methods of the invention, they can possibly be used in a non-encapsulated form.

The agricultural active formulation of the present invention or the liquid carrier concentrate of the present invention may be applied by any convenient means, familiar to those skilled in the art, such as, for instance, spraying, soil application, in-furrow treatment or side-dressing.

The following examples illustrate the invention without limiting however the scope thereof.

### Examples

### Methodologies Description

### Standard Procedure for Microbial Viability Assessment of Liquid Carrier Concentrates Upon Accelerated Storage Stability Study (Shelf-Life Assessment)

Liquid carrier concentrates were prepared by mixing 5 wt % of microbial biopesticide commercial product (powder form), 3 wt % of a rheology modifier, and 92 wt % of solvent.

The commercial products tested were in powder form, and the beneficial microorganisms in the products were either:
Beauveria bassiana, or
Paecilomyces lilacinus, or
Trichoderma harzianum

For comparison, two control experiments, without the solvent and the rheology modifier, were prepared. 5 wt % of the powder commercial product was added to 95 wt % soybean oil, or Dowanol DPM (commercial solvent used as a liquid carrier for fungi)

The preparations were incubated under accelerated temperature test conditions, at 25° C. for Beauveria bassiana and Paecilomyces lilacinus, and 30° C. for Trichoderma harzianum and the viability of the microorganism was evaluated after 0, 7, 15 and 30 days of incubation, without agitation. Trials were performed in duplicates.

### Microorganisms Viability Evaluation

To confirm that the microorganisms were viable after determined incubation/storage time, traditional serial dilution and plating of the samples for colony counting were performed.

Samples of 0.1 mL were taken from each preparation and added to 0.9 mL of an aqueous solution containing 0.1% of Tween 80 (polyoxyethylene sorbitan monooleate) to obtain a 10⁻¹ dilution. Then 0.1 mL of this dilution was added to 0.9 mL of the same aqueous solution successively until the most appropriate dilution was obtained (usually between 10⁻⁴ and 10⁻⁷). 0.2 mL of the most appropriate dilutions were spread into petri dishes containing the proper culture media for each microorganism and incubated (at 25° C. for Beauveria bassiana and Paecilomyces lilacinus and at 30° C. for Trichoderma harzianum), until the colony grew.

The number of the colonies on each petri dish was counted and the results are expressed by colony forming units (CFU)/mL.

### Liquid Carrier Concentrate Stability Evaluation

Liquid carrier concentrates were prepared as follows: rheology modifier and surfactants (if present) were weighed in a 250 ml beaker at the targeted amount, followed by addition of the solvent or carrier. The whole mixture was stirred at 500 revolutions per minute (rpm) during 10-15 minutes until homogeneous. The pre-calculated amount of microorganism powder to reach 5 wt % was then added into the pre-mix under magnetic stirring at 500-700 rpm for 20-25 minutes until the mixture is homogeneous.

The compositions were put under storage stability at targeted temperatures and the evolution of the appearance was monitored. The percentage of phase separation corresponds to the measured height of syneresis versus total height of the formulation in the container.

### Dispersion Stability Assessment Upon Dilution in Water

The dilution characteristics of the liquid carrier concentrates of the invention were assessed by adopting a method adapted from CIPAC MT 41.1 standard. Certain amount (98 mL for the case of fungi and 90 mL for the case of bacteria) of CIPAC D water was introduced into a 100 ml conical test tube, then a pre-calculated amount of the homogeneous concentrated formulation (2 mL for the case of fungi and 10 mL for the case of bacteria) was poured directly into the test tube followed by 10 manual inversions of the diluted. The sample was then left on the bench top under static condition. Visual observations at t=0, 30 minutes, 2 hours and 24 hours were carried out and the thickness of eventual sediment on the bottom was recorded with precision of 0.1 mL. After the observation at 24 hours, the sample was again inverted 10 times manually for re-dispersion, before left aside for another 30 minutes and the final stability status was recorded. In certain cases to accelerate the development process comparisons were based only on 2 hours observations.

### Raw Materials Used

Dowanol DPM (dipropylene glycol methyl ether)
Augeo® SL191 (2,2-dimethyl-4-hydroxymethyl-1,3-dioxolane)
Aerosil® R 202 (fumed silica surface-treated with polydimethylsiloxane)
Aerosil® 200 (hydrophilic fumed silica)
Aerosil® R 974 (fumed silica treated with dimethyldichlorosilane)
Tixosil® 365 (precipitated amorphous silica)
Bentone® DY-CE (organically modified smectite clay)
Attagel® 40 (attapulgite)
Soprophor® BSU (tristyrylphenol ethoxylate (16EO))
Soprophor® CY/8 (tristyrylphenol ethoxylate (20EO))
Soprophor® TSP/461 (ethopropoxylated tristyrylphenol)
Geropon® DA1349 (acrylic comb graft copolymer)

### Results

### 1. Microbial Viability Assessment of Liquid Carrier Concentrates Upon Accelerated Storage Stability Study (Shelf-Life Assessment)

The viability of the microorganisms in various liquid carrier concentrates was evaluated at the end of 7 days, 15 days and 1 month, following methodology previously described.

TABLE 1

| | | Compar- | Compar- |
|---|---|---|---|
| | | ative | ative |
| | Example 1 | Example 1a | Example 1b |
| Beneficial | Beauveria bassiana | | |
| microorganism | | | |
| Solvent (and possibly | Augeo ® | Soybean | Dowanol |
| rheology modifier) | SL191 + 3 wt % | oil | DPM |
| | Aerosil ® R202 | | |
| Initial microorganism | 2.48E+07 | | |
| viability (CFU/mL) | | | |
| Viability after 7 days | 1.89E+07 | 6.50E+06 | 3.50E+05 |
| Viability after 15 days | 1.25E+07 | 5.00E+06 | 5.00E+04 |
| Viability after 1 month | 1.45E+07 | 2.60E+06 | 2.20E+04 |

For Beauveria bassiana, the microbial viability after 1 month storage at 25° C. of the liquid carrier concentrate of Example 1 containing Augeo® SL191 and Aerosil® R202 was significantly higher (1.45E+07 CFU/mL) than the microbial viability obtained for the composition of comparative Example 1a (2.60E+06 CFU/mL), and than the microbial viability obtained for the composition of comparative Example 1b (2.20E+04 CFU/mL).

TABLE 2

| | | Compar- | Compar- |
|---|---|---|---|
| | | ative | ative |
| | Example 2 | Example 2a | Example 2b |
| Beneficial | Paecilomyces lilacinus | | |
| microorganism | | | |
| Solvent (and possibly | Augeo ® | Soybean | Dowanol |
| rheology modifier) | SL191 + 3 wt % | oil | DPM |
| | Aerosil ® R202 | | |
| Initial microorganism | 2.61E+07 | | |
| viability (CFU/mL) | | | |
| Viability after 7 days | 1.26E+07 | 1.00E+06 | 3.00E+05 |
| Viability after 15 days | 1.51E+07 | 1.68E+06 | too low |
| | | | to count |
| Viability after 1 month | 1.33E+07 | 1.50E+06 | too low |
| | | | to count |

For Paecilomyces lilacinus, the microbial viability after 1 month storage at 25° C. of the liquid carrier concentrate of Example 2 containing Augeo® SL191 and Aerosil® R202 was significantly higher (1.33E+07 CFU/mL) than the microbial viability obtained for the composition of comparative Example 2a (1.50E+06 CFU/mL), and than the microbial viability obtained for the composition of comparative Example 2b (too low to count).

TABLE 3

| | | Compar- | Compar- |
|---|---|---|---|
| | | ative | ative |
| | Example 3 | Example 3a | Example 3b |
| Beneficial | Trichoderma harzianum | | |
| microorganism | | | |
| Solvent (and possibly | Augeo ® | Soybean | Dowanol |
| rheology modifier) | SL191 + 3 wt % | oil | DPM |
| | Aerosil ® R202 | | |
| Initial microorganism | 1.90E+05 | | |
| viability (CFU/mL) | | | |
| Viability after 7 days | 1.63E+05 | 1.10E+05 | 1.25E+03 |
| Viability after 15 days | 1.58E+05 | 1.60E+05 | 7.50E+02 |
| Viability after 1 month | 3.50E+05 | 1.30E+05 | 2.35E+02 |

For Trichoderma harzianum, the microbial viability after 1 month storage at 30° C. of the liquid carrier concentrate of Example 3 containing Augeo® SL191 and Aerosil® R202 was slightly superior than the microbial viability obtained for the composition of comparative Example 3a and was significantly higher than the microbial viability obtained for the composition of comparative Example 3b.

The results above (Tables 1-3) showed that the liquid carrier concentrate containing Augeo® SL191 and Aerosil® R202 was not harmful for the microorganisms.

Moreover, the liquid carrier concentrates of examples 1, 2 and 3 displayed very satisfactory suspension properties for the various microorganism particles whereas for comparative examples 1a, 1b, 1c, 2a, 2b, 2c, 3a, 3b and 3c rapid sedimentation was observed.

### 2. Physical Storage Stability of Liquid Carrier Concentrates

Three different beneficial fungi were respectively formulated as a liquid carrier concentrate to reach a final composition of 5% microorganism, 92% Augeo® SL191 and 3% Aerosil® R202, and the resulted liquid carrier concentrate were put under storage stability ar 54° C. during 1 week and at room temperature (24° C.) during 1 month. Besides Aerosil® R202, three other types of silicas as rheology modifier (Aerosil® R974, Aerosil® 200, Tixosil® 365) were also tested in such formulations and storage conditions. From tables below it can be seen that among all cases, only liquid carrier concentrates containing Augeo® SL191 and Aerosil® R202 displayed satisfactory storage stability in the different conditions of temperature, with phase separation below 5% and an easy redispersion for all three microorganisms. Alternative classes of rheology modifiers such as attapulgite (Attagel® 40) and an organically modified smectite clay (Bentone® DY-CE) were also tested with Augeo® SL191 with the considered microorganisms, but a rapid phase separation was observed.

Other comparative examples were given by keeping the same rheology modifier, i.e. Aerosil® R202, while only changing the Augeo® SL191 solvent to a commercial benchmark solvent, Dowanol DPM. The results showed that the comparative association of Dowanol DPM and Aerosi® R202 did not generate a satisfactory storage stability, contrary to the combination of Augeo® SL191 and Aerosil® R202.

### 2.1. Storage Stability at 54° C. During 1 Week

TABLE 4

| 54° C., | Beneficial | Beauveria | Paecilomyces | Trichoderma |
|---|---|---|---|---|
| 1 week | microorganism | bassiana | lilacinus | harzianum |
| Example 4 | Augeo ® SL191 + | Phase | Phase | Phase |
| | Aerosil ® R202 | separation <5% | separation <5% | separation <5% |
| | | Easily | Easily | Easily |
| | | redispersible | redispersible | redispersible |
| Comparative | Augeo ® SL191 + | Phase | Phase | Phase |
| Example 4a | Aerosil ® R974 | separation ~83% | separation ~83% | separation ~83% |
| | | Cake formation | Cake formation | Cake formation |
| | | Not redispersible | Not redispersible | Not redispersible |
| Comparative | Augeo ® SL191 + | Phase | Phase | Phase |
| Example 4b | Aerosil ® 200 | separation ~50% | separation ~42% | separation ~50% |
| | | Gel formation | Gel formation | Gel formation |
| | | Not redispersible | Not redispersible | Not redispersible |
| Comparative | Augeo ® SL191 + | Phase | Phase | Phase |
| Example 4c | Tixosil ® 365 | separation ~75% | separation ~83% | separation ~83% |
| | | Cake formation | Cake formation | Cake formation |
| | | Not redispersible | Not redispersible | Not redispersible |
| Comparative | Dowanol DPM + | Phase | Phase | Phase |
| Example 4d | Aerosil ® R202 | separation ~33% | separation ~50% | separation ~50% |
| | | Gel formation | Gel formation | Gel formation |
| | | Not redispersible | Not redispersible | Not redispersible |

### 2.2. Storage Stability at Room Temperature During 1 Month

TABLE 5

| 24° C., | Beneficial | Beauveria | Paecilomyces | Trichoderma |
|---|---|---|---|---|
| 1 month | microorganism | bassiana | lilacinus | harzianum |
| Example 5 | Augeo ® SL191 + | Phase | Phase | Phase |
| | Aerosil ® R202 | separation <5% | separation <5% | separation <5% |
| | | Easily | Easily | Easily |
| | | redispersible | redispersible | redispersible |
| Comparative | Augeo ® SL191 + | Phase | Phase | Phase |
| Example 5a | Aerosil ® R974 | separation ~83% | separation ~83% | separation ~67% |
| | | Cake formation | Cake formation | Cake formation |
| | | Not redispersible | Not redispersible | Not redispersible |
| Comparative | Augeo ® SL191 + | Phase | Phase | Phase |
| Example 5b | Aerosil ® 200 | separation ~50% | separation ~50% | separation ~58% |
| | | Gel formation | Gel formation | Gel formation |
| | | Not redispersible | Not redispersible | Not redispersible |
| Comparative | Augeo ® SL191 + | Phase | Phase | Phase |
| Example 5c | Tixosil ® 365 | separation ~83% | separation ~67% | separation ~83% |
| | | Cake formation | Cake formation | Cake formation |
| | | Not redispersible | Not redispersible | Not redispersible |
| Comparative | Dowanol DPM + | Phase | Phase | Phase |
| Example 5d | Aerosil ® R202 | separation ~50% | separation ~50% | separation ~50% |
| | | Gel formation | Gel formation | Gel formation |
| | | Not redispersible | Not redispersible | Not redispersible |

3. Liquid Carriers Concentrates with Additional Surfactants or Polymers

A liquid carrier concentrate (example 6), containing 5 wt % of Trichoderma harzianum (commercial product TrikoLogic® 1E+8 spores/g), 89 wt % Augeo@ SL191, 3 wt % Acrosil® R202 and 3 wt % Soprophor® BSU, was prepared. The stability after 1 month storage at 20° C. of the formulation was proven to be very good, with phase separation less than 5% and easy afterward re-dispersion without agglomeration of particles. However, in a liquid carrier concentrate without Aerosil® R202 (containing only 5 wt % microorganism, 92 wt % Augeo® SL191 and 3 wt % of Soprophor® BSU), a pronounced phase separation (>80%) took place rapidly within minutes. This highlighted again the importance of fumed silica surface-treated with PDMS in structuring the liquid carrier to bring excellent liquid carrier concentrate stability upon storage.

The dispersion characteristics of liquid carrier concentrate of example 6 in water CIPAC D were evaluated by diluting 2 mL of liquid carrier concentrate in 98 mL of water CIPAC D, to achieve a dilution concentration of 0.1% wt/v of Trichoderma harzianum powder in water. A good ease of dispersion was achieved.

Additional liquid carriers concentrates (examples 7a, 7b, 7c) were prepared, containing 5 wt % of Trichoderma harzanium powder, 89 wt % of Augeo® SL191, 3 wt % of Aerosil® R202 and 3 wt % of surfactant (Soprophor® CY/8 in example 7a, Geropon® DA1349 in example 7b, Soprophor® TSP/461 in example 7c). Liquid carrier concentrates of examples 7a, 7b, 7c displayed very satisfactory physical stability upon storage. Upon dilution into water, according to the procedure described above, a good ease of dispersion was achieved, similar to the one observed with Soprophor® BSU, or even slightly higher with Geropon® DA1349.

A liquid carrier concentrate (example 8), containing 5 wt % of Bacillus thuringiensis powder (commercial product Delfin® 4.85E+10 (FUJ g), 89 wt % Augeo® SL191, 2.5 wt % Aerosil® R202 and 3 wt % Soprophor® BSU, was prepared. The stability after 1 month storage at 20° C. of the liquid carrier concentrate was proven to be satisfactory, with limited phase separation and a good ease of redispersion.

Interestingly, as the liquid carrier concentrate with Augeo® SL191 does not contain water, the need for introduction of a preservative to prevent pathogens growth in the concentrate can be avoided. Such a preservative can indeed be harmful to the viability of Bacillus spores, impacting drastically their germination rate and it is thus an advantage to avoid the presence of such preservatives in a water-free carrier.

The same liquid carrier concentrate was also evaluated in terms of dispersibility in water to reach 0.5% of Bacillus thuringiensis in the final dilution, and the behavior was found to be good.

1. A liquid carrier concentrate comprising at least one beneficial microorganism selected from the group consisting of Bacillus, Streptomyces, Beauveria, Trichoderma, Metarhizium, Paecilomyces, Isaria, Baculovirus, Azospirillum, Penicillium and Rhizobium, at least one dioxolane-based solvent and at least one rheology modifier, said rheology modifier being a fumed silica surface-treated with polydimethylsiloxane.

2. The liquid carrier concentrate according to claim 1 wherein the at least one beneficial microorganism is selected from the group consisting of Bacillus, Beauveria, Trichoderma, Metarhizium, Paecilomyces, Isaria, Baculovirus, Azospirillum, Penicillium and Rhizobium, in particular from the group consisting of Beauveria, Trichoderma, Metarhizium, Penicillium, Paecilomyces, Isaria, Baculovirus and Azospirillum.

3. The liquid carrier concentrate according to claim 1 wherein the at least one beneficial microorganism is selected from the group consisting of Bacillus, Beauveria, Trichoderma, Paecilomyces and Rhizobium.

4. The liquid carrier concentrate according to claim 1 wherein the dioxolane-based solvent is a compound of formula (I): 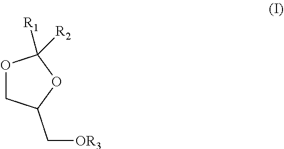
wherein:
R₁ and R₂, independent from one another, are selected from the group consisting of: a linear or branched C₁-C₁₂ alkyl, a C₄-C₁₂ cycloalkyl or an aryl;
R₃ is H, a linear or branched alkyl, a cycloalkyl, or a —C(═O)R₄ group; and
R₄ is a linear or branched C₁-C₄ alkyl or C₅-C₆ cycloalkyl.

5. The liquid carrier concentrate according to claim 1 wherein R₁ and R₂, independently from one another, are selected from the group consisting of: methyl, ethyl, isopropyl, n-propyl, isobutyl, n-butyl, tert-butyl, n-pentyl, cyclopentyl, cyclohexyl or phenyl.

6. The liquid carrier concentrate according to claim 1 wherein R₃ is H or a —C(═O)R₄ group, and R₄ is methyl, ethyl, isopropyl, n-propyl, isobutyl, n-butyl or tert-butyl.

7. The liquid carrier concentrate according to claim 1 wherein R₁ is methyl, R₂ is phenyl and R₃ is H.

8. The liquid carrier concentrate according to claim 1 wherein R₁ and R₂ are methyl and R₃ is H.

9. The liquid carrier concentrate according to claim 1 wherein R₁ and R₂ are methyl, R₃ is a —C(═O)R₄ group, and R₄ is methyl.

10. The liquid carrier concentrate according to claim wherein the fumed silica surface-treated with polydimethylsiloxane has a BET-specific surface area ranging from 60 to 180 m²/g.

11. The liquid carrier concentrate according to claim 1 wherein the fumed silica surface-treated with polydimethylsiloxane has a BET specific surface area ranging from 60 to 140 m²/g.

12. A liquid carrier concentrate comprising:
at least one beneficial microorganism selected from the group consisting of Bacillus, Beauveria, Trichoderma, Metarhizium, Paecilomyces, Isaria, Baculovirus, Azospirillum, Penicillium and Rhizobium;
at least one solvent, this solvent being a compound of formula (I): 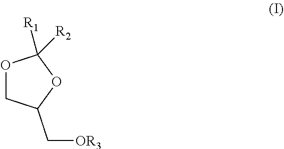
wherein R₁ and R₂ are methyl, and R₃ is H; and
at least one rheology modifier, said rheology modifier being a fumed silica surface-treated with polydimethylsiloxane having a BET specific surface area ranging from 60 to 180 m²/g.

13. A liquid carrier concentrate comprising:
at least one beneficial microorganism selected from the group consisting of Bacillus, Beauveria, Trichoderma, Metarhizium, Paecilomyces, Isaria, Baculovirus, Azospirillum, Penicillium and Rhizobium;
at least one solvent, this solvent being a compound of formula (I): 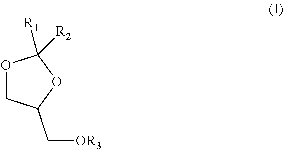
wherein R₁ and R₂ are methyl, R₃ is a —C(═O)R₄ group, and R₄ is methyl; and
at least one rheology modifier, said rheology modifier being a fumed silica surface-treated with polydimethylsiloxane having a BET specific surface area ranging from 60 to 180 m²/g.

14. The liquid carrier concentrate according to claim 1, further comprising at least one surfactant.

15. The liquid carrier concentrate according to claim 1 comprising at least 40 wt % of said solvent based on the total weight of the liquid carrier.

16. The liquid carrier concentrate according to claim 1 further comprising at least one additional agricultural material chosen from pesticides different from the said beneficial microorganism agents as described above, nutrients, biostimulants, plant growth regulators, and mixtures thereof.

17. An agricultural active formulation comprising the liquid carrier concentrate as defined in claim 1.

18. An agricultural active formulation obtained by diluting or dispersing the liquid carrier concentrate as defined in claim 1.

19. A method for treating soils, plants and/or seeds to control pests and/or to regulate the growth of plants and/or to induce the defense response in plants and/or to enhance metabolic and physiological processes within plants and soils, by applying the liquid carrier concentrate as defined in claim 1 or an agricultural active formulation comprising the liquid carrier concentrate to at least one plant, area adjacent to a plant, soil adapted to support growth of a plant, root of a plant, foliage of a plant, and/or seed adapted to produce a plant.

20. A method for treating plants and/or seeds to control pests and/or to regulate the growth of plants and/or to induce the defense response in plants and/or to enhance metabolic and physiological processes within plants, by applying the liquid carrier concentrate as defined in claim 1 or an agricultural active formulation comprising the liquid carrier concentrate to at least one plant, area adjacent to a plant, root of a plant, foliage of a plant, and/or seed adapted to produce a plant.

21. The method according to claim 19 wherein an effective amount of the agricultural active formulation or of the liquid carrier concentrate is applied to plants (crop or undesired ones), seeds or to the soil.

22. (canceled)
